(19) United States
(12) Patent Application Publication
(10) Pub. No.: US 2022/0391631 A1
(43) Pub. Date: Dec. 8, 2022

(54) POST-HOC LOCAL EXPLANATIONS OF BLACK BOX SIMILARITY MODELS

(71) Applicants: International Business Machines Corporation, Armonk, NY (US); RENSSELAER POLYTECHNIC INSTITUTE, Troy, NY (US)

(72) Inventors: Zaid Bin Tariq, Islamabad (PK); Karthikeyan Natesan Ramamurthy, Pleasantville, NY (US); Dennis Wei, Sunnyvale, CA (US); Amit Dhurandhar, Yorktown Heights, NY (US)

(21) Appl. No.: 17/382,310

(22) Filed: Jul. 21, 2021

(30) Foreign Application Priority Data
Jun. 8, 2021 (PK) 427/2021

(51) Int. Cl. G06K 9/62; G06N 20/00

(52) U.S. Cl. CPC G06K 9/6215; G06K 9/6262; G06N 20/00

(57) ABSTRACT

Define a similarity measure between first and second points in a data space by operation of a machine learning model. Generate interpretable representations of the first and second points. Generate an interpretable local description of the similarity measure by approximating the similarity measure as a distance between the interpretable representations of the first and second points. The distance between the interpretable representations incorporates a matrix. Learn values for the matrix through optimizing a loss function evaluated on perturbations of the first and second points. Explain a value of the similarity measure between the first and second points using elements of the matrix. Assess the explanation of the value of the similarity measure using a rubric. In response to the assessment of the explanation of the value of the similarity measure, modify the machine learning model. Deploy the modified machine learning model.

### BACKGROUND

The present invention relates to the electrical, electronic, and computer arts, and more specifically, to machine learning.

The goal of a similarity function is to quantify the similarity between two objects. The learning of similarity functions from labeled examples has traditionally been studied within the area of similarity or metric learning. With the advent of deep learning, learning complex similarity functions, or equivalently, distance functions, has found its way into additional important applications such as health care informatics, facial recognition, handwriting analysis/signature verification, and matching queries for search engines. For example, learning pairwise similarity between patients in Electronic Health Records (EHR) helps doctors in diagnosing and treating future patients. Although deep similarity and metric learning models may improve the quantification of similarity in complex domains, the complexity of these models makes trusting their predictions a challenge for the user.

### SUMMARY

Principles of the invention provide techniques for post-hoc local explanations of black box similarity models. In one aspect, an exemplary method includes defining a similarity measure between first and second points in a data space by operation of a machine learning model; generating interpretable representations of the first and second points; generating an interpretable local description of the similarity measure by approximating the similarity measure as a distance between the interpretable representations of the first and second points, wherein the distance between the interpretable representations incorporates a matrix; learning values for the matrix through optimizing a loss function evaluated on perturbations of the first and second points; explaining a value of the similarity measure between the first and second points using elements of the matrix; assessing the explanation of the value of the similarity measure using a rubric; in response to the assessment of the explanation of the value of the similarity measure, modifying the machine learning model; and then deploying the modified machine learning model.

According to another aspect, an exemplary method includes defining a similarity measure between a first pair of points in a data space by operation of a machine learning model and estimating a value of the similarity measure between the first pair of points; finding matching pairs of points in the data space, wherein each matching pair of points has a similar value for the similarity measure as does the first pair of points; explaining the value of the similarity measure between the first pair of points using analogy to the matching pairs of points; assessing the explanation of the value of the similarity measure using a rubric; and, in response to the assessment of the explanation of the value of the similarity measure, modifying the machine learning model.

One or more embodiments of the invention or elements thereof can be implemented in the form of a computer program product including a computer readable storage medium with computer usable program code for facilitating the method steps indicated. Furthermore, one or more embodiments of the invention or elements thereof can be implemented in the form of a system (or apparatus) including a memory that embodies computer executable instructions, and at least one processor that is coupled to the memory and operative by the instructions to facilitate exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a tangible computer readable storage medium (or multiple such media) and implemented on a hardware processor, or (iii) a combination of (i) and (ii); any of (i)-(iii) implement the specific techniques set forth herein.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

In view of the foregoing, techniques of the present invention can provide substantial beneficial technical effects. For example, one or more embodiments provide one or more of:

Model-agnostic explanations of similarity judgments.

Explanations independent of data modalities.

Enhanced understanding why two instances are similar from feature and exemplar perspectives, thereby calibrating trust in the prediction made by the machine.

Debugging black-box model before deployment.

Increased confidence in operational accuracy and reliability of automated systems controlled by machine learning models.

Within statistical limits (such as random sampling, datasets used), the feature and exemplar explanations provided are mathematically optimal.

Flexibility of using different representations for interpretability in feature-based explanations, and ability to control the complexity of explanation.

Flexibility of using different notions of fidelity, analogousness, and diversity in exemplar-based explanations, and ability to control the number of analogous pairs.

For decision-critical systems such as clinical predictive modeling and patient diagnosis, allow the user to understand the reasons why a black box similarity model assigns a certain level of similarity to two given objects, thus building confidence by providing explanations for similarity models.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a post-hoc local explainer system, according to an exemplary embodiment.

FIG. 2 depicts a method for feature-based explanation of a similarity model, according to an exemplary embodiment.

FIG. 3 depicts a method for analogy-based explanation of a similarity model, according to an exemplary embodiment.

FIG. 4 depicts an exemplary pair of sentences that are compared by a similarity model, according to an exemplary embodiment.

FIG. 5 depicts distance contribution matrix for the pair of sentences shown in FIG. 4, according to an exemplary embodiment.

FIG. 6 depicts two pairs of sentences that are compared by a similarity model, according to an exemplary embodiment.

FIG. 7 depicts a distance contribution matrix for a pair of the sentences shown in FIG. 6, according to an exemplary embodiment.

FIG. 8 depicts a distance contribution matrix for another pair of sentences, according to an exemplary embodiment.

FIG. 9 depicts mean absolute errors for feature-based explanations compared to black box model similarity estimates, according to an exemplary embodiment.

FIGS. 10A, 10B, 10C depict mean absolute errors for analogy-based explanations compared to black box model similarity estimates, according to an exemplary embodiment.

FIG. 11 depicts a cloud computing environment according to an embodiment of the present invention.

FIG. 12 depicts abstraction model layers according to an embodiment of the present invention.

FIG. 13 depicts a computer system that may be useful in implementing one or more aspects and/or elements of the invention, also representative of a cloud computing node according to an embodiment of the present invention.

### DETAILED DESCRIPTION

A similarity model is a machine learning tool that produces estimates of how similar statements or images are to each other. Often, similarity models are trained unsupervised. Typically, similarity models are black-box models, i.e., there is no transparency as to how the models produce the similarity estimates. Similarity models are applied to practical effect in various fields. For example, similarity models have applications in ranking, in recommendation systems, visual identity tracking, face verification, and speaker verification. In the medical domain, identifying similar pairs of patients based on clinical contexts can be used to perform case-based reasoning, group patients into cohorts, compare the effects of treatments, and create personalized recommendations of care. In all these situations, explanations can be useful to justify the rationale behind the similarities. In the regulatory domain, chemical processing facilities can be ranked by their similarity to one or more facilities that have failed inspections, and the similarity ranking can be used to schedule inspections of the facilities not yet inspected.

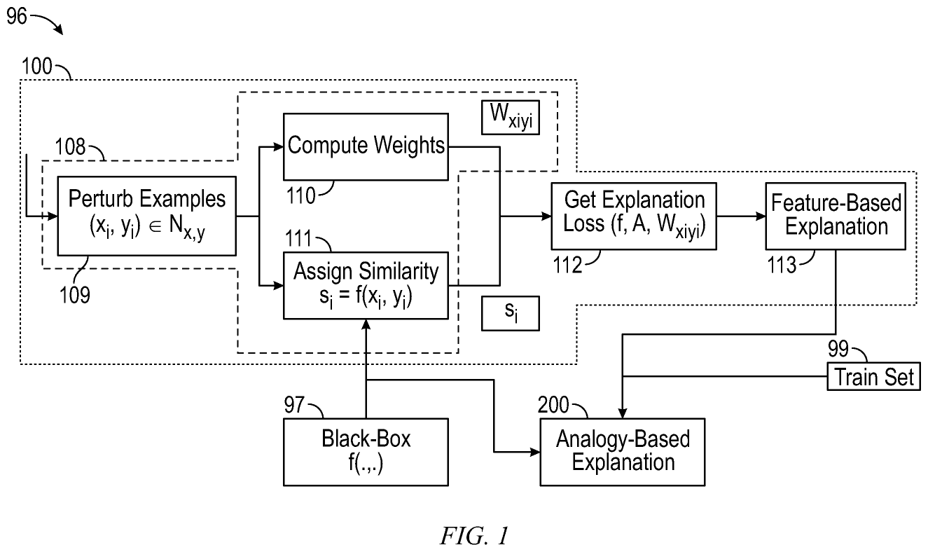

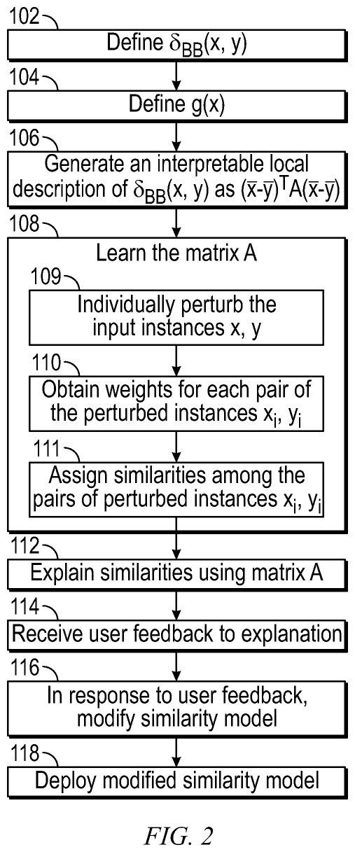

According to aspects of the invention, a post-hoc local explainer system 96 (shown in FIG. 1) implements a method 100 for feature-based explanation of a black-box similarity model 97 and a method 200 for analogy-based explanation of the black-box similarity model. The explanations introduce transparency as to how the model produces similarity estimates sᵢ from input data (“train set”) 99. Some aspects of FIG. 1 are also described with reference to FIG. 2, following.

Generally, the methods 100 and 200 are local explanation methods for similarity learners. Given a black box similarity learner and a pair of inputs, method 100 attributes the output of the black box to particular features of the input. This method is a confluence of Local Interpretable Model-agnostic Explanations and regression similarity learning. Meanwhile, method 200 contributes (somewhat) complementary explanations in the form of analogies for a given input pair.

Given a pair of examples x=(x₁, x₂) ∈ R^{m}⊗R^{m}, where m is the dimensionality of the space, and a black box model δ_{BB}(.): R^{m}⊗R^{m}→R, a goal of one or more embodiments of the invention is to “explain” a prediction δ_{BB}(x) made by the black box model. One type of explanation takes the form of a sparse set of features (i.e., number of features is <<m if m is large, e.g., greater than 20) that are most important in determining the output, possibly together with weights to quantify their importance. An alternative form of explanation includes other example pairs that have the same (or similar) output from the black box model as the input pair. The latter form, i.e., pairs corresponding to an input pair, constitutes a new form of (local) explanation which is referred to herein as analogy-based explanation. Although analogy-based explanations might seem to be similar to exemplar-based explanations, which also are used to locally explain classification models, there is a significant difference: Exemplar-based explanations are typically close to the input they explain, while analogy-based explanations do not have to be. What is desired in one or more embodiments is for the relationship between members of each analogous pair to be close to the relationship of the input pair (x₁, x₂).

Also considering FIG. 2, the method 100 for feature-based explanation, which attempts to explain the similarity between two points in a data space, as predicted by the black box model, uses features from the data points themselves (some of the steps in FIG. 2 are also shown in FIG. 1). At 102, define δ_{BB} (x, y) as a distance function between two points x and y, i.e., smaller δ_{BB}(x, y) values imply greater similarity. In one or more embodiments, δ_{BB} is implemented as a machine learning model that is trained by expert judgment. It is not important whether δ_{BB} satisfies all four axioms of a metric, although many distance functions used in practice are non-negative and symmetric and the approximation proposed below is more suitable under these conditions than when δ_{BB} lacks such properties. At 104, define another function g(x), which creates an interpretable representation x̅:=g(x) of a data point x. For example, if the data point x represents a sentence, then x̅:=g(x) could be a vector of 1s and 0s that represent the presence or absence in x of words from a vocabulary. A suitable vocabulary could include only the words present in sentences to be compared. Optionally, stop words (e.g., “the,” “a,” “and”) could be left out of the vocabulary; other stop words are known by the ordinary skilled worker.

The broad concept of a “vocabulary” is not limited to compilations of words, but could include compilations of discrete numeric measurement values, buckets of values, or the like. For example, in a medical context, an interpretable vocabulary of plural medical charts could include features such as “systolic blood pressure between 90 and 110,” “systolic blood pressure between 110 and 120,” “systolic blood pressure above 130.” In a regulatory context, an interpretable vocabulary of plural facility profiles could include features such as “groundwater depth less than 10 meters,” “groundwater depth more than 30 meters,” “wetlands distance less than 100 meters,” “wetlands distance more than 500 meters.”

If the features (i.e., the individual components of x) are already interpretable, then g(x) can be the identity function. The explanation will operate on the interpretable representation. Thus, at 106, generate an interpretable local description of δ_{BB}(x, y) at (x;y) by approximating it with the Mahalanobis distance (x̅-y̅)^{T} A(x̅-y̅) between the interpretable representations x̅ and y̅, where A [symbol] 0.

At 108, learn the matrix A by minimizing the following weighted square loss over a set of perturbations (xᵢ; yᵢ) of the input pair (x; y):

$${min}_{A ≽ 0} {\sum }_{( {x}_{i} , {y}_{i} ) ∈ {𝒩}_{xy}} {{w}_{{x}_{i} , {y}_{i}} ( {δ}_{B B} ( {x}_{i} , {y}_{i} ) - {( {\overline{x}}_{i} - {\overline{y}}_{i} )}^{T} A ( {\overline{x}}_{i} - {\overline{y}}_{i} ) )}^{2} .$$

The loss captures the fidelity of the Mahalanobis approximation to the black box model over a neighborhood [symbol] of (x; y). This also can be formulated (for a “diagonal” parameter α=diag (A₁₁, . . . , Aₙₙ)) as

$${min}_{a} {\sum }_{( {x}_{i} , {y}_{i} ) ∈ {𝒩}_{x y}} {{w}_{{x}_{i} {y}_{i}} ( {δ}_{B B} ( {x}_{i} , {y}_{i} ) - {a}^{T} {d}_{{x}_{i} {y}_{i}}^{2} )}^{2} ,$$

$$s . t . a ≽ 0.$$

For non-negative weights wₓ_{ᵢ}_{, y}_{ᵢ}, the optimization problem is a convex minimization because 1) the quadratic form is linear in A, 2) this is composed with a weighted least squares objective, and 3) the set of semidefinite matrices A [symbol] 0 is convex. In one or more embodiments, weights are obtained by first perturbing the input instances, then computing the weights based on the perturbed and original inputs.

At 109, individually perturb the input instances x, y to produce the data points (xᵢ, yⱼ) ∈ [symbol] . In the case of words in a sentence, the perturbation simply removes one or more words (the result may no longer be a human-comprehensible sentence). In the case of numerical features like blood pressure or groundwater depth, perturbation means adding a small amount of noise to the value.

For each example, estimate the conditional probability of a feature j belonging to different categories given all the other feature values. These conditional probabilities can be used to sample categories for feature j to generate perturbations. To ensure closeness to the original category, a small constant is added to the conditional probability of the original category and re-normalized, similar to an additive smoothing scheme. This can be repeated for all categorical features to obtain perturbed examples. In one or more embodiments, the conditional probability estimator is a logistic regression model that predicts the categories of a feature j using the rest of the features in the dataset.

In one or more embodiments, weights are obtained at 110 by first computing weights wₓₓ_{ᵢ} and w_{yy}_{ᵢ} for each generated instance xᵢ and yᵢ, respectively. An exponential kernel is used to compute each weight, e.g.,

$${w}_{x {x}_{i}} = exp ( - \frac{D ( x , {x}_{i} )}{{σ}^{2}} )$$

as a function of distance

D between the generated instance and the corresponding input instance. Then final weight wₓ_{ᵢ}_{, y}_{ᵢ} is given by the sum wₓ_{ᵢ}_{, y}_{ᵢ}=wₓₓ_{ᵢ}+w_{yy}_{ᵢ}.

At 111, in parallel to obtaining the weights, assign similarities sᵢ among each of the input pairs (xᵢ,yᵢ) according to black-box function sᵢ=f(xᵢ,yᵢ).

At 112, produce a feature-based explanation 113 (see FIG. 1) that explains the similarity of the two instances x, y using elements of the learned A matrix. The elements of the learned A matrix provide insights into the important features responsible for the similarity. Generally, the magnitude of an element suggests how much it contributes to the similarity measure.

At 114, receive user feedback to the explanation of the similarity. At 116, in response to the user feedback (e.g., concern about the explanation), modify the similarity model (black-box function f(xᵢ,yᵢ)) by removing features that should not contribute to the similarity/Mahalanobis distance calculation, based on subject matter expert heuristics, and retraining the model. Similarly, if multiple features appear significant to many local explanations, but do not have a causal reason for co-occurring, one or more of the co-occurring features can be randomly removed to reduce processor load and improve compute times of the similarity model. The exemplary modification removes inputs, but the model itself also changes because of the retraining. After retraining without those inputs, it will generally adjust its parameters to compensate. The retrained model will then be better (output more accurate similarities) than not retraining and e.g., setting the excluded inputs to zero or some baseline value. Alternatively, if the explanation is satisfactory to the user, the similarity model can be deployed as-is.

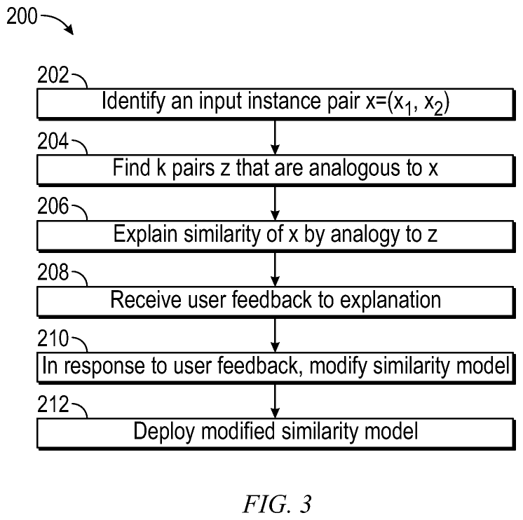

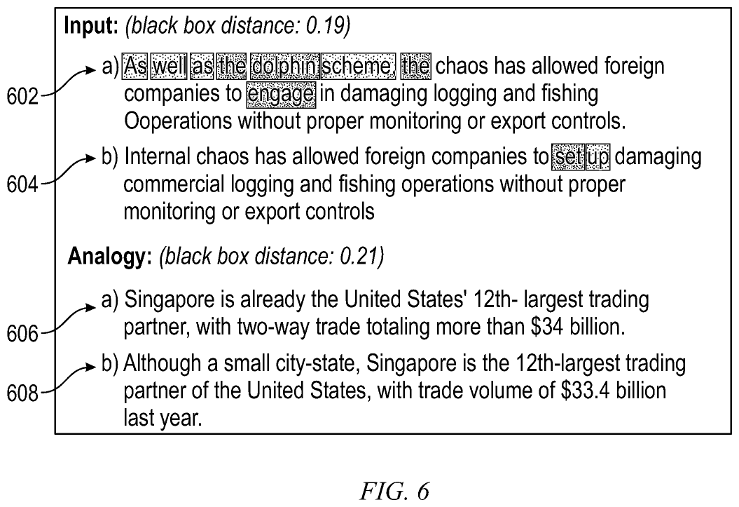

FIG. 3 depicts an exemplary method 200 for analogy-based explanation. Method 200 is driven by an objective function that is based on the intuitive desiderata of (1) closeness in degree of similarity as the input pair, (2) diversity among the analogous pairs, and (3) a notion of analogy, i.e., members of each analogous pair have a similar relationship to each other as members of the input pair. An example analogy is shown in FIG. 6, where more context is present in one of the sentences (i.e., Singapore being a small city-state) similar to the input pair (i.e., dolphin scheme). Different intensities of shading around words (features) of the sentences indicate which features contribute more or less to the similarity measure. It is proven that the objective is submodular, making it efficient to find good analogies within a large dataset. Given an input example pair x:=(x₁, x₂), a black box model δ_{BB}, and an analogy closeness function G(zᵢ,x), the goal is to identify a set of diverse pairs of examples from the dataset that have the same (or similar) relationship to each other as the input pair. For example, consider two patients who have similar disease conditions (input pair). The analogous pairs will be other pairs of patients who are also similar to each other in their disease conditions but are perhaps socio-economically diverse. Note that the individual examples in the analogous pairs do not have to be similar to the examples in the input pair; rather, their relationship should be maintained. That is, in the medical example, the patients in the analogous pairs may not have the same socioeconomic characteristics as the patients in the input pair, and an analogous pair may both have disease B whereas the input pair has disease A. Since the analogous pairs do not directly report important features, one might argue that they could be difficult to interpret. However, they could uncover latent factors that a feature-based explanation described in the previous section may not. Moreover, they can be a more unbiased and effective way of explaining an input pair as they leave room for the human to use the human's knowledge and judgement in identifying what factors are important based on the pattern observed in the analogies.

At 202, identify an input instance pair x=(x₁, x₂) that are deemed to be “similar” by the black-box model δ_{BB}. In the dataset containing x, pairs of examples z are defined as zᵢ=(zᵢ₁, zᵢ₂) for i ∈ {1, . . . , N}. Assume

δₘᵢₙ(zᵢ, zⱼ)=min[δ_{BB} ((zᵢ₁, zⱼ₁))+δ_{BB} ((zᵢ₂, zⱼ₂)), δ_{BB} ((zᵢ₁, zⱼ₂))+δ_{BB} ((zᵢ₂, zⱼ₁)).

Then, at 204, k pairs z that are analogous to x can be found by solving an optimization problem with λ₁, λ₂≥0:

$${arg min}_{{z}_{1} , … , {z}_{k}} {\sum }_{i = 1}^{k} {( {δ}_{B B} ( {z}_{i} ) - {δ}_{B B} ( x ) )}^{2} + {λ}_{1} {\sum }_{i = 1}^{k} G ( {z}_{i} , x ) - {λ}_{2} {\sum }_{i = 1}^{k} {\sum }_{j = 1}^{k} {δ}_{min}^{2} ( {z}_{i} , {z}_{j} ) .$$

The first term in the optimization problem urges the analogous pair zi to have a similar distance between its members (zᵢ₁,zᵢ₂) as the input pair (x₁,x₂), according to the black box model. The last term tries to encourage diversity in the analogous pairs such that the individual instances are different across pairs, although the similarity/difference within a pair is close to that of the input pair. The function δₘᵢₙ² (zᵢ, zⱼ) determines which of two pairs (zᵢ,zⱼ) has the better matching (less distance) between its members.

The analogy closeness term G(zᵢ,x) is defined as

$$G ( {z}_{i} , x ) = D ( {z}_{i} , x ) + {α ( {δ}_{I} ( {z}_{i} ) - {δ}_{I} ( x ) )}^{2} ,$$

$$D ( {z}_{i} , x ) = 1 - \frac{{( ϕ ( {z}_{i 2} ) - ϕ ( {z}_{i 1} ) )}^{T} ( ϕ ( {x}_{2} ) - ϕ ( {x}_{1} ) )}{‖ ϕ ( {z}_{i 2} ) - ϕ ( {z}_{i 1} ) ‖ ‖ ϕ ( {x}_{2} ) - ϕ ( {x}_{1} ) ‖}$$

where δ₁(x) is the distance predicted by the feature-based explanation method 100. Including this term with weight α>0 may be helpful when the feature-based explanation is faithful and can aid in direct interpretation of the analogies. The term D(zᵢ,x) is the cosine distance between the directions ϕ(zᵢ₂)-ϕ(zᵢ₁) and ϕ(x₂)-ϕ(x₁) in an embedding space with ϕ as the embedding function (which could be the identity function). Generally, the directions between items in a pair capture aspects of the relationships between the items, and pairs for which the directions are closely similar express similar relationships.

At 206, explain the similarity of the input pair x by analogy to the discovered pairs. At 208, receive user feedback to the explanation of the similarity. At 210, in response to the user feedback (e.g., concern about the explanation), modify the similarity model (black-box function f(xᵢ,yᵢ) by removing features that do not contribute to the explanation. Another possibility is that the user finds that the similarity is explained by a latent factor that is suggested by the analogies but not well-represented by the existing input features. The user then constructs a second model that, given a pair of examples, quantifies the degree to which this latent factor is present. The output of this second model could then be provided as an additional input to the black-box similarity model. As discussed earlier, retraining the similarity model with this additional input would change it.

Alternatively, if the explanation is satisfactory to the user, at 212 the similarity model can be deployed as-is.

The optimization problems mentioned herein can be solved in various ways. In experimental work, CVXPY (an open-source Python-embedded mathematical modeling language) was used to formulate and solve the optimization problems.

Examples of FbFull (feature-based full) and AbE (analogy-based) explanations are now discussed to illustrate insights that may be obtained from studying the explanations.

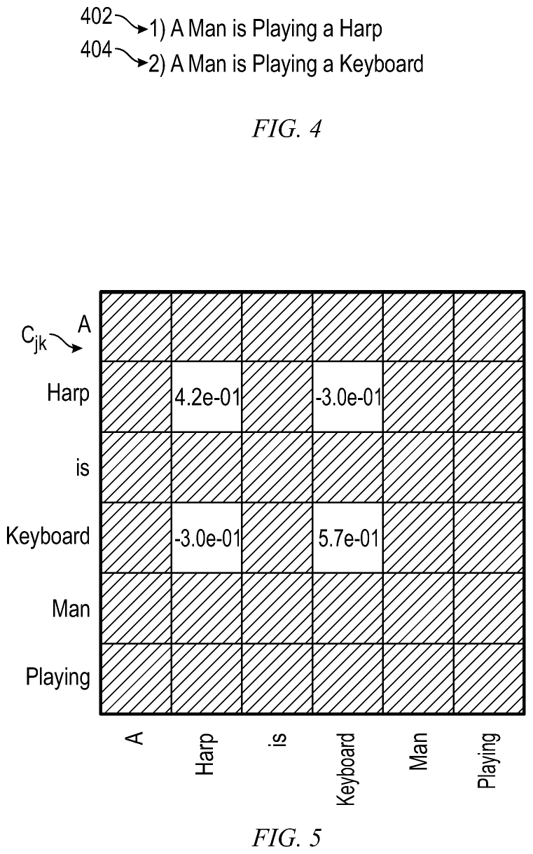

Example 1: To start with a simple example, consider the pair of sentences shown in FIG. 4. This pair was assigned a distance of 0.38 by the black box (BB) similarity model. FbFull approximates the above distance by the Mahalanobis distance (x̅-y̅)^{T} A(x̅-y̅). The interpretable representation x̅ is a binary vector with each component x̅ᵢ indicating whether a word is present in the sentence. Define the distance contribution matrix C as the matrix whose elements Cⱼₖ:=(x̅ⱼ-y̅ⱼ)Aⱼₖ(x̅ₖ-y̅ₖ) are summed to give the Mahalanobis distance. The distance contributions Cⱼₖ for Example 1 are shown in FIG. 5. Since the substitution of “keyboard” for “harp” is the only difference between the sentences, these are the only rows/columns with nonzero entries. A diagonal element Cjj is the contribution due to one sentence having word j and the other lacking it (e.g., x̅ⱼ=1, y̅ⱼ=0). Interestingly, the diagonal elements are partially offset by negative off-diagonal elements Cⱼₖ, which represent a contribution due to substituting word j (x̅ⱼ=1, y̅ⱼ=0) for word k (x̅ₖ=0, y̅ₖ=1). It can be presumed that the offset occurs because harp and keyboard are both musical instruments and thus somewhat similar.

AbE gives the following top three analogies:

1a) A guy is playing hacky sack

1b) A man is playing a keyboard. (BB distance: 0.40)

2a) Women are running.

2b) Two women are running. (BB distance: 0.19)

3a) Yes a team must use the same player for both pitching and batting in the National League.

3b) There's a rule that decides which players can be picked for pitching/batting in the National League. (BB distance: 0.59)

The first analogy is very similar except that hacky sack is a sport rather than a musical instrument. The sentences in the second pair are more similar than the input pair; this is reflected in the corresponding BB distance. The third analogy is less related (both sentences are about baseball player selection) but its BB distance is also larger.

Example 2: Next we consider the pair of longer sentences 602, 604 from FIG. 6. The BB distance between this pair is 0.19 so they are closer than in Example 1. The two sentences are mostly the same but the first one adds context about an additional dolphin scheme.

The analogy 606, 608 in FIG. 6 is a good match because like the input pair, the analogous pair makes the same statement but one of the sentences gives more context (Singapore being a small city-state).

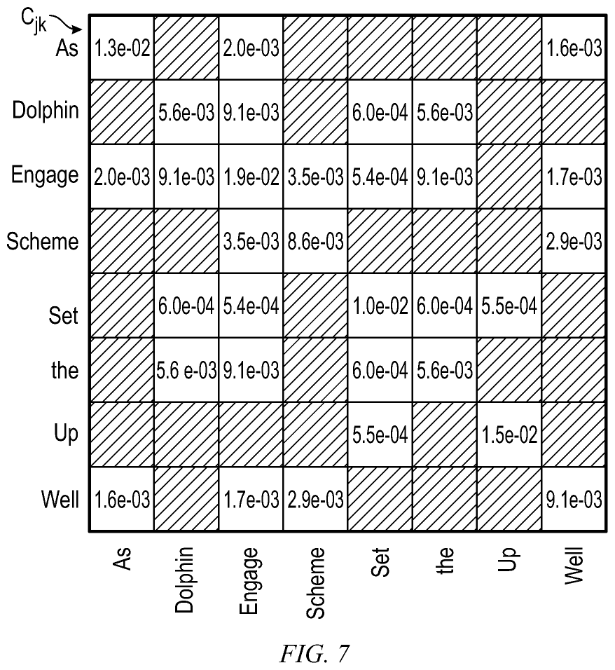

The distance contribution matrix given by FbFull, for the first pair of sentences in FIG. 6, is plotted in FIG. 7. For clarity, only significant rows/columns with absolute sum greater than 0.01 are shown. Several of the words with the largest contributions come from the additional phrase about the dolphin scheme. The substitution of the verb “set up” for “engage” is also highlighted.

Example 3: Another pair of sentences are both more complex than Example 1 and less similar than Example 2 (BB distance 0:44):

a) It depends on what you want to do next, and where you want to do it.

b) I guess it depends on what you're going to do.

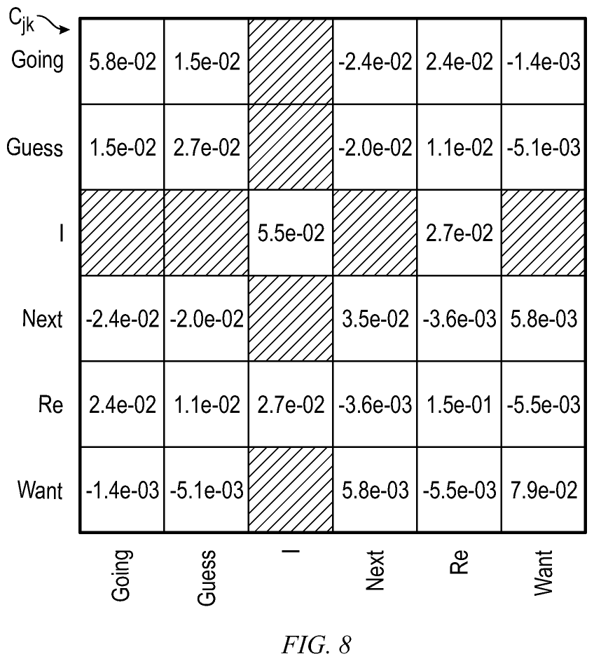

FIG. 8 shows the distance contribution matrix produced by FbFull for this pair of sentences, again restricted to significant rows/columns (absolute sum greater than 0.01). The most important contributions identified are the substitution of “[a]re going” for “want” and the addition of “I guess” in sentence b). Of minor importance but interesting to note is that the word “next” in sentence a) would have a larger contribution but it is offset by negative contributions from the (“next”, “going”) and (“next”, “guess”) entries. Both “next” and “going” are indicative of future action.

Below is the top analogy for Example 3 (BB distance 0:45):

1a) I prefer to run the second half 1-2 minutes faster than the first.

1b) I would definitely go for a slightly slower first half.

Both sentences express the same idea (second half faster than first half) but in different ways, similar to the input pair.

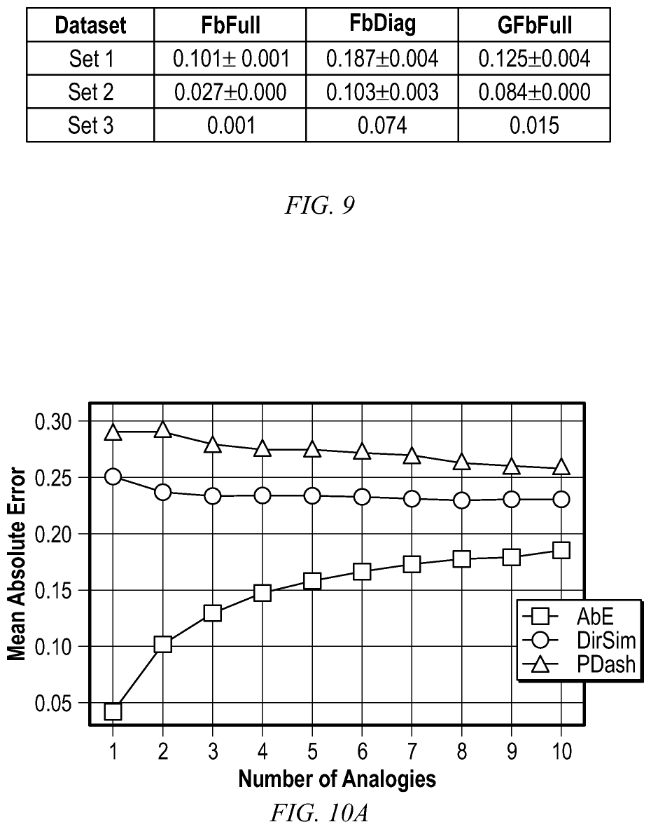

This section presents comparisons of fidelity in terms of MAE. For the feature-based explanations, FIG. 9 shows the MAE of the predictions from FbFull, FbDiag, and GFbFull with respect to the black box predictions. FbFull is the feature-based prediction using the full matrix for distance calculation FbDiag uses only the diagonal cells of the matrix for distance calculation; it runs faster than FbFull. GFbFull is the global version of FbFull in that the matrix A is fit to all examples in the training set rather than perturbations of a single example pair. Clearly, FbFull has superior performance, which is not surprising since it is better than FbDiag in modeling the local behavior of the black box model. Also, its locality helps in capturing fine-grained variations in the black box model compared to GFbFull.

Since all the black box predictions are between 0 and 1, it is possible to compare these three datasets. The first observation is that all feature-based explanations perform well on Dataset 1, which suggests that the black box universal sentence encoder agrees with the local Mahalanobis distance approximation and can be explained well using this model. Dataset 2 also shows reasonable performance for FbFull, which supports the same argument, albeit more weakly. Dataset 3 shows the worst performance, perhaps because the dataset is so small that a conjoined neural network cannot approximate the underlying similarity function well.

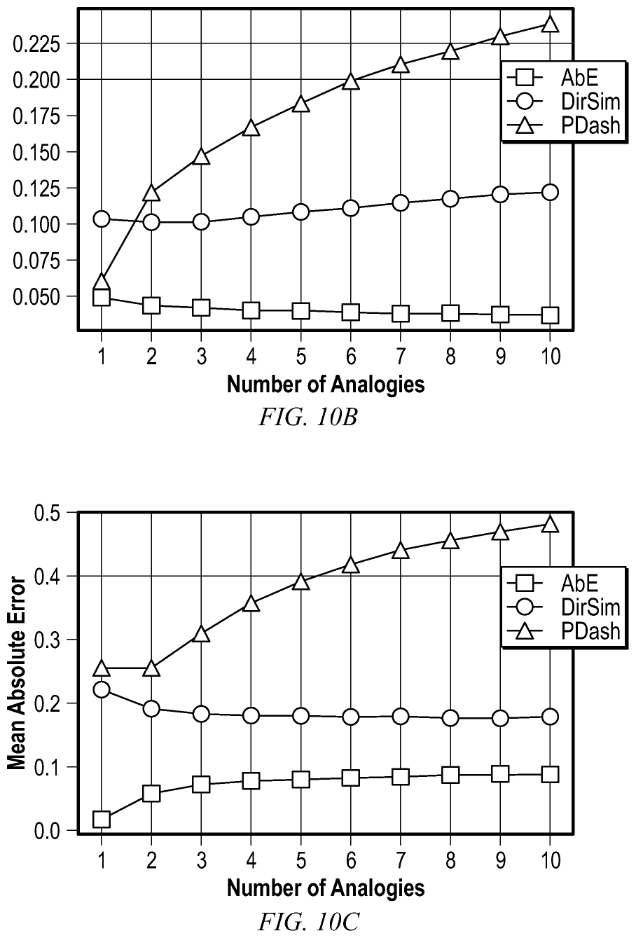

The performance of the analogy explanation methods (AbE, DirSim, and PDash) is illustrated in FIG. 10. For a given set of analogies, the prediction of the explainer is computed as the average of the black box predictions for the analogies. The proposed AbE method dominates the other two baselines because of the explicit inclusion of the black box fidelity term in the objective. For Dataset 1 and 3, the MAE of AbE steadily increases with the number of analogies. This is expected because of a trade-off between the fidelity term and the diversity term as k increases. On the other hand, for Dataset 2, the MAE of AbE very slowly reduces and flattens out. This could be due to the greater availability of high-fidelity analogous pairs in Dataset 2. It is also supported by the fact that for a reasonable number of analogies (e.g., 3), the MAE of AbE is quite small and close to FbFull for Dataset 2, whereas it is larger than FbFull for the other datasets.

Given the discussion thus far, it will be appreciated that, in general terms, an exemplary method 100, according to an aspect of the invention, includes several steps. At 102, define a similarity measure between first and second points in a data space by operation of a machine learning model. At 104, generate interpretable representations of the first and second points. At 106, generate an interpretable local description of the similarity measure by approximating the similarity measure as a distance between the interpretable representations of the first and second points, wherein the distance between the interpretable representations incorporates a matrix. At 110, learn values for the matrix through optimizing a loss function evaluated on perturbations of the first and second points. At 112, explain a value of the similarity measure between the first and second points using elements of the matrix. At 114, assess the explanation of the value of the similarity measure using a rubric. At 116, in response to the assessment of the explanation of the value of the similarity measure, modify the machine learning model. Then, at 118, deploy the modified machine learning model.

In one or more embodiments, the method further comprises modifying the machine learning model by eliminating at least one feature from a vocabulary of the model and then retraining the model with the reduced vocabulary. Alternatively, a feature could be added to the vocabulary in response to a user's imposition of domain knowledge on the model results.

In one or more embodiments, the interpretable representations of the first and second points are vectors of binary elements, each element representing presence or absence of a feature from a vocabulary of the first and second points. In one or more embodiments, the vocabulary of the first and second points comprises a plurality of words. In one or more embodiments, the vocabulary of the first and second points comprises a plurality of numeric value buckets.

In one or more embodiments, perturbing the first and second points comprises setting binary elements to zero to represent removal of features from the vocabulary, or addition of a small random value to a numeric value. In one or more embodiments, optimizing a loss function evaluated on perturbations of the first and second points by varying elements of the learned matrix A.

In one or more embodiments, the method further comprises deploying the machine learning model to operate an electrical distribution network.

In one or more embodiments, the method further comprises deploying the machine learning model to produce preliminary diagnoses of hospitalized patients.

According to another aspect, an exemplary method 200 includes several steps. At 202, define a similarity measure between a first pair of points in a data space by operation of a machine learning model and estimating a value of the similarity measure between the first pair of points. At 204, find matching pairs of points in the data space, wherein each matching pair of points has a similar value for the similarity measure as does the first pair of points. At 206, explain the value of the similarity measure between the first pair of points using analogy to the matching pairs of points. At 208, assess the explanation of the value of the similarity measure using a rubric. At 210, in response to the assessment of the explanation of the value of the similarity measure, modify the machine learning model.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

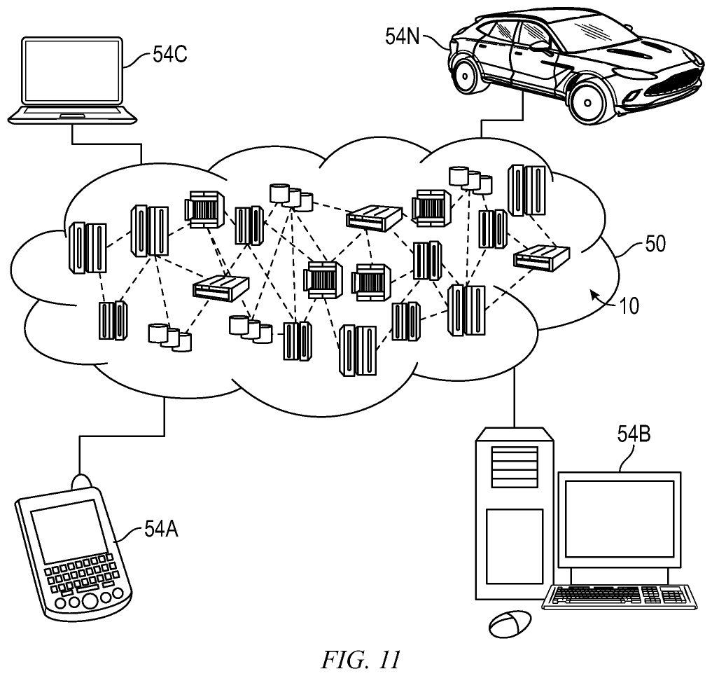

Referring now to FIG. 11, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 11 are intended to be illustrative only and that computing nodes 10 and cloud computing environment 50 can communicate with any type of computerized device over any type of network and/or network addressable connection (e.g., using a web browser).

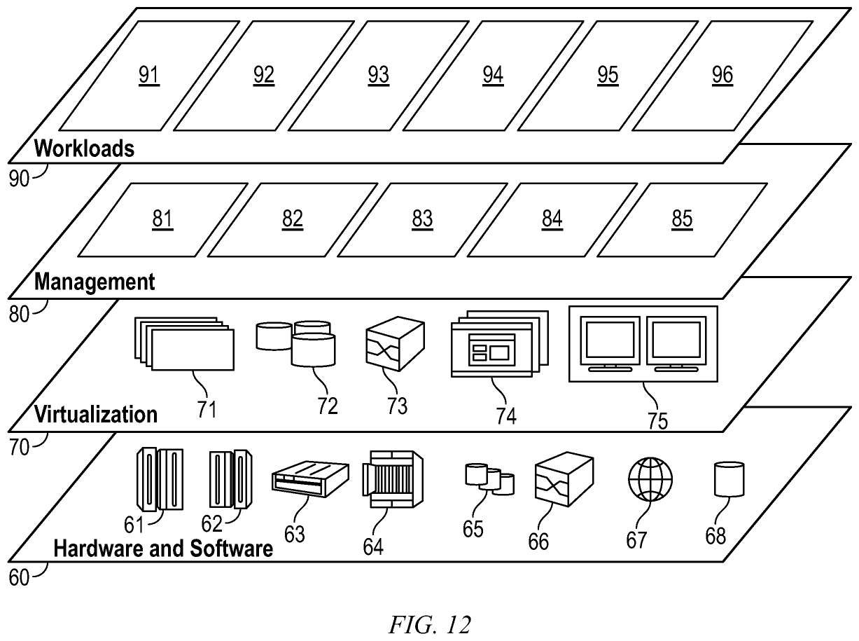

Referring now to FIG. 12, a set of functional abstraction layers provided by cloud computing environment 50 (FIG. 11) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and the post-hoc local explainer system 96 or portions thereof.

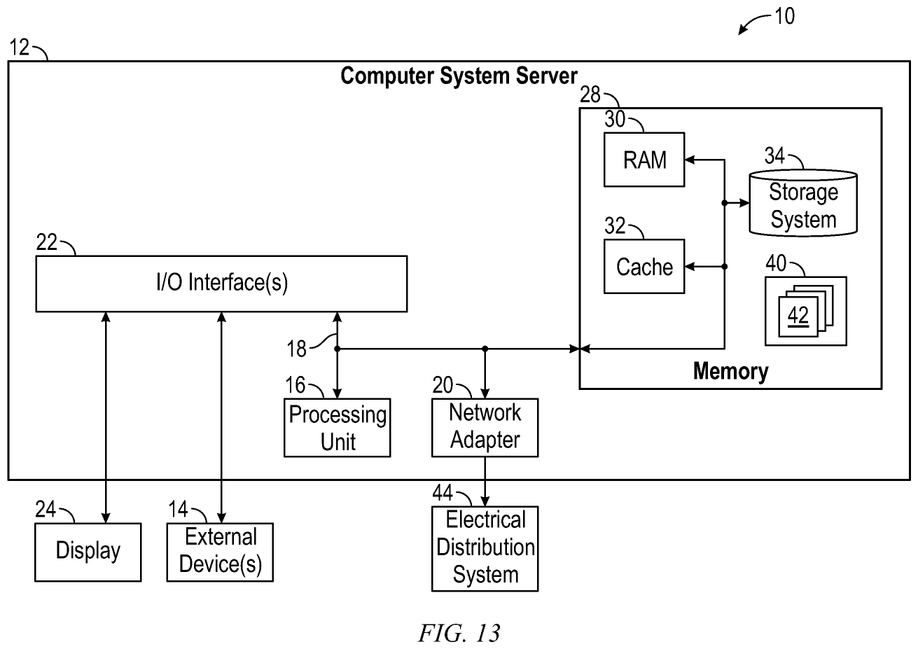

One or more embodiments of the invention, or elements thereof, can be implemented in the form of an apparatus including a memory and at least one processor that is coupled to the memory and operative to perform exemplary method steps, or in the form of a non-transitory computer readable medium embodying computer executable instructions which when executed by a computer cause the computer to perform exemplary method steps. FIG. 13 depicts a computer system that may be useful in implementing one or more aspects and/or elements of the invention, also representative of a cloud computing node according to an embodiment of the present invention. Referring now to FIG. 13, cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 13, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc. As another example, via the network adapter 20 the system/server 12 can connect with and control an electrical distribution system 44 (e.g., by controlling a switch network); fluid flow could also be controlled (e.g., by controlling a valve network), and the like.

Thus, one or more embodiments can make use of software running on a general purpose computer or workstation. With reference to FIG. 13, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 13) running a server program. It will be understood that such a physical server may or may not include a display and keyboard.

One or more embodiments can be at least partially implemented in the context of a cloud or virtual machine environment, although this is exemplary and non-limiting. Reference is made back to FIGS. 11-12 and accompanying text.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

Exemplary System and Article of Manufacture Details [IBM Mandated Boilerplate that Cannot be Changed in Any Way]

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
defining a similarity measure between first and second points in a data space by operation of a machine learning model;
generating interpretable representations of the first and second points;
generating an interpretable local description of the similarity measure by approximating the similarity measure as a distance between the interpretable representations of the first and second points, wherein the distance between the interpretable representations incorporates a matrix;
learning values for the matrix through optimizing a loss function evaluated on perturbations of the first and second points;
explaining a value of the similarity measure between the first and second points using elements of the matrix;
assessing the explanation of the value of the similarity measure using a rubric;
in response to the assessment of the explanation of the value of the similarity measure, modifying the machine learning model; and
deploying the modified machine learning model.

2. The method of claim 1, wherein modifying the machine learning model comprises eliminating at least one feature from a vocabulary of the model.

3. The method of claim 1, wherein, in the step of generating interpretable representations, the interpretable representations of the first and second points comprise vectors of binary elements, each element representing presence or absence of a feature from a vocabulary of the first and second points.

4. The method of claim 3, wherein the vocabulary of the first and second points comprises a plurality of words.

5. The method of claim 3, wherein the vocabulary of the first and second points comprises a plurality of numeric value buckets.

6. The method of claim 1, wherein perturbing the first and second points comprises at least one of setting binary elements to zero to represent removal of features from the vocabulary, and addition of a small random value to a numeric value.

7. The method of claim 1, further comprising deploying the machine learning model to operate an electrical distribution network.

8. The method of claim 1, further comprising:
deploying the machine learning model to produce preliminary diagnoses of hospitalized patients; and
treating at least one of the hospitalized patients consistent with at least a corresponding one of the preliminary diagnoses.

9. A method comprising:
defining a similarity measure between a first pair of points in a data space by operation of a machine learning model;
estimating a value of the similarity measure between the first pair of points;
finding matching pairs of points in the data space, wherein each matching pair of points has a similar value for the similarity measure as does the first pair of points;
explaining the value of the similarity measure between the first pair of points using analogy to the matching pairs of points;
assessing the explanation of the value of the similarity measure using a rubric; and
in response to the assessment of the explanation of the value of the similarity measure, modifying the machine learning model.

10. A computer program product comprising one or more computer readable storage media that embody computer executable instructions, which when executed by a computer cause the computer to perform a method comprising:
defining a similarity measure between first and second points in a data space by operation of a machine learning model;
generating interpretable representations of the first and second points;
generating an interpretable local description of the similarity measure by approximating the similarity measure as a distance between the interpretable representations of the first and second points, wherein the distance between the interpretable representations incorporates a matrix;
learning values for the matrix through optimizing a loss function evaluated on perturbations of the first and second points;
explaining a value of the similarity measure between the first and second points using elements of the matrix;
assessing the explanation of the value of the similarity measure using a rubric;
in response to the assessment of the explanation of the value of the similarity measure, modifying the machine learning model; and
deploying the modified machine learning model.

11. The computer readable medium of claim 10, further comprising modifying the machine learning model by eliminating at least one feature from a vocabulary of the model.

12. The computer readable medium of claim 10, wherein the interpretable representations of the first and second points are vectors of binary elements, each element representing presence or absence of a feature from a vocabulary of the first and second points.

13. The computer readable medium of claim 12, wherein the vocabulary of the first and second points comprises a plurality of words.

14. The computer readable medium of claim 12, wherein the vocabulary of the first and second points comprises a plurality of numeric value buckets.

15. The computer readable medium of claim 10, wherein perturbing the first and second points comprises at least one of setting binary elements to zero to represent removal of features from the vocabulary, and addition of a small random value to a numeric value.

16. An apparatus comprising:
a memory embodying computer executable instructions; and
at least one processor, coupled to the memory, and operative by the computer executable instructions to perform a method comprising:
defining a similarity measure between first and second points in a data space by operation of a machine learning model;
generating interpretable representations of the first and second points;
generating an interpretable local description of the similarity measure by approximating the similarity measure as a distance between the interpretable representations of the first and second points, wherein the distance between the interpretable representations incorporates a matrix;
learning values for the matrix through optimizing a loss function evaluated on perturbations of the first and second points;
explaining a value of the similarity measure between the first and second points using elements of the matrix;
assessing the explanation of the value of the similarity measure using a rubric;
in response to the assessment of the explanation of the value of the similarity measure, modifying the machine learning model; and
deploying the modified machine learning model.

17. The apparatus of claim 16, wherein the interpretable representations of the first and second points comprise vectors of binary elements, each element representing presence or absence of a feature from a vocabulary of the first and second points.

18. The apparatus of claim 17, wherein the vocabulary of the first and second points comprises a plurality of words.

19. The apparatus of claim 18, wherein modifying the machine learning model comprises eliminating at least one feature from a vocabulary of the model.

20. The apparatus of claim 17, wherein the vocabulary of the first and second points comprises a plurality of numeric value buckets.
